(19) United States
(12) Patent Application Publication
(10) Pub. No.: US 2008/0201961 A1
(43) Pub. Date: Aug. 28, 2008

(54) Electric nibbler

(75) Inventors: Jiun-Rung Wu, Taichung Industrial Park (TW); Chih-Hua Hsu, Taichung Industrial Park (TW)

Correspondence Address: BACON & THOMAS, PLLC, 625 SLATERS LANE, FOURTH FLOOR, ALEXANDRIA, VA, 22314, US

(73) Assignee: TECHWAY INDUSTRIAL CO., LTD., Taichung (TW)

(21) Appl. No.: 11/709,714

(22) Filed: Feb. 23, 2007

(51) Int. Cl. B26B 17/00

(52) U.S. Cl. 30/180

(57) ABSTRACT

An electric nibbler has a handle, a battery package, a front cover, a base, a lower blade, a drive device, a transmitting device and an upper blade. The battery package is detachably attached to the battery seat of the handle. The front cover is mounted securely to the handle and has a mounting bracket and a housing. The base is connected securely to the housing and has an upper segment and a lower segment. The lower blade is connected securely to the lower segment. The drive device is mounted in the handle and a drive shaft. The transmitting device is connected to the drive device and has a connecting tube, a transmitting shaft, a drive axle, a gear wheel, a crank and a piston rod. The upper blade is connected securely to the bottom end of the piston rod.

### BACKGROUND OF THE INVENTION

1. Field of the Invention

The present invention relates to an electric hand tool, and more particularly relates to an electric nibbler that can be used safely, conveniently and quickly.

2. Description of Related Art

With reference to FIG. 7, a conventional electric nibbler (60) is used to cut a sheetmetal and has a handle and an operating head. The handle has a front end, a rear end and a power cord. The power cord is connected to the rear end of the handle, is used to conduct electricity from an outlet to the conventional electric nibbler (60). The operating head is formed on the front end of the handle and has a bottom, an extending shaft (61) and a bottom base (62). The extending shaft (61) is protruded on the bottom of the operating head and has a lower end and a punch pin (63). The punch pin (63) is movably mounted on the lower end of the extending shaft (61). The bottom base (62) is connected securely to the extending shaft (61) below the punch pin (63). A user can insert the sheetmetal between the extending shaft (61) and the bottom base (62) and cut the sheetmetal by the punch pin (63).

With reference to FIGS. 8 and 9, another conventional electric nibbler (70) has a body, a drive device (72), a jacket (71), a passive blade (74), a drive blade (73) and multiple elastic elements (75). The body has a front end, a rear end and a handle. The handle is formed on the rear end of the body. The drive device (72) is mounted in the front end of the body, is connected to the handle and has an outer end and a drive shaft (720). The drive shaft (720) is rotatably and eccentrically mounted on the outer end of the drive device (72). The jacket (71) is connected to the outer end of drive device (72) around the drive shaft (720) and has an internal surface. The passive blade (74) is connected to the jacket (71) and has an outer side, an inner side, a middle, a mounting hole and a cutting edge (741). The outer side of the passive blade (74) is connected to the internal surface of the jacket (71) by bolts. The mounting hole is formed through the middle of the passive blade (74). The drive blade (73) is connected to the drive device (72) in the jacket (71), is connected to the passive blade (74) and has an outer side, an inner side, a middle, a mounting hole, an engaging edge (731) and a cutting edge (732). The outer side of the drive blade (73) contacts with the internal surface of the jacket (71). The inner side of the drive blade (73) faces to the inner side of the passive blade (74). The mounting hole is formed through the middle of the drive blade (73) and is aligned with the mounting hole of the passive blade (74). The drive blade (73) is pivotally connected to the passive blade (74) by a fastener extending through the mounting holes of the blades (73, 74). The engaging edge (731) is U-shaped, is extended into the jacket (71) and is mounted around the drive shaft (720) of the drive device (72). The cutting edge (732) is extended out the jacket (71) and abuts against the cutting edge (741) of the passive blade (74). The elastic elements (75) are mounted in the inner side of the passive blade (74) and abut with the inner side of the drive blade (73). When the drive shaft (720) is rotated eccentrically by the drive device (72), the engaging edge (731) of the drive blade (73) is moved by the drive shaft (720). Then, the cutting edge (732) of the drive blade (73) is moving up and down relative to the cutting edge (741) of the passive blade (74). Therefore, a user can cut a sheetmetal by inserting a sheetmetal between the cutting edges (731, 741) of the blades (73, 74).

However, the conventional electric nibbler (60, 70) has the following shortcomings.

1. When a sheetmetal is cut with the conventional electric nibbler (60), the metal filings are produced by the punch pin (63), and this will cause material waste and the working space dirty.

2. Furthermore, the momentum of the punch pin (63) is large, and the user cannot control the conventional electric nibbler (60) easily and may get hurt by the punch pin (63).

3. When the sheetmetal is cut with the conventional electric nibbler (70), the sheetmetal cannot be supported by the blades (73, 74), and the cutting speed of the conventional electric nibbler (70) is slow so the conventional electric nibbler (70) is inconvenient in use.

4. When the blades (73, 74) of the conventional electric nibbler (70) are worn down, to change the worn blades (73, 74) is difficult and troublesome.

To overcome the shortcomings, the present invention provides an electric nibbler to mitigate or obviate the aforementioned problems.

### SUMMARY OF THE INVENTION

The main objective of the present invention is to provide an electric nibbler that can be used safely, conveniently and quickly.

The electric nibbler has a handle, a battery package, a front cover, a base, a lower blade, a drive device, a transmitting device and an upper blade. The battery package is detachably attached to the battery seat of the handle. The front cover is mounted securely to the handle and has a mounting bracket and a housing. The base is connected securely to the housing and has an upper segment and a lower segment. The lower blade is connected securely to the lower segment. The drive device is mounted in the handle and a drive shaft. The transmitting device is connected to the drive device and has a connecting tube, a transmitting shaft, a drive axle, a gear wheel, a crank and a piston rod. The upper blade is connected securely to the bottom end of the piston rod.

Other objectives, advantages and novel features of the invention will become more apparent from the following detailed description when taken in conjunction with the accompanying drawings.

### BRIEF DESCRIPTION OF THE DRAWINGS

FIG. 1 is a perspective top view of an electric nibbler in accordance with the present invention;

FIG. 2 is another perspective view of the electric nibbler in FIG. 1;

FIG. 3 is a perspective view in partial section of the electric nibbler in FIG. 1;

FIG. 4 is an exploded perspective view of a transmitting device of the electric nibbler in FIG. 3;

FIG. 5 is a front view in partial section of the electric nibbler in FIG. 1;

FIG. 6 is an operational front view in partial section of the electric nibbler in FIG. 5;

FIG. 7 is a perspective view of a conventional electric nibbler in accordance with the prior art;

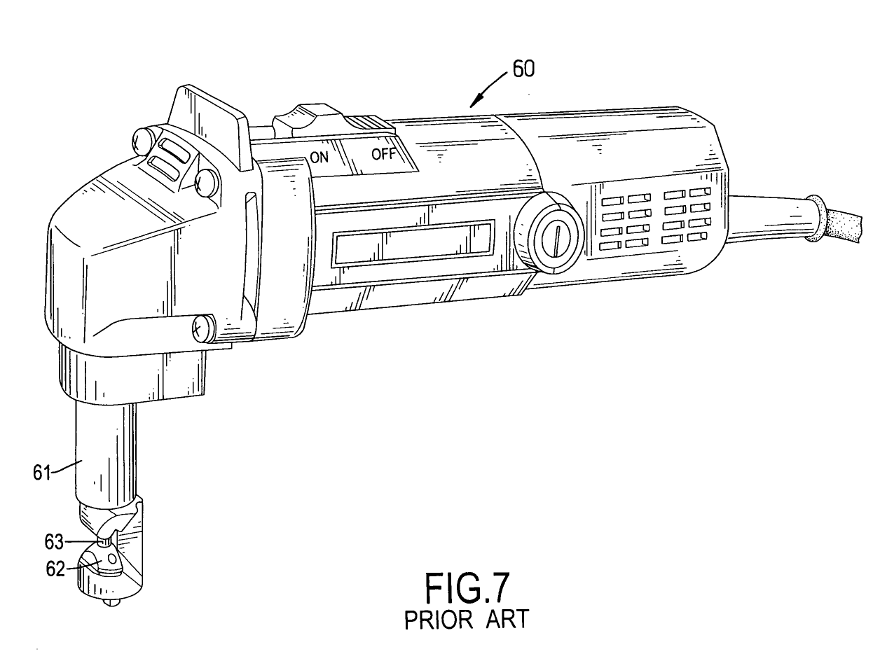

FIG. 8 is a side view in partial section of another conventional electric nibbler in accordance with the prior art; and

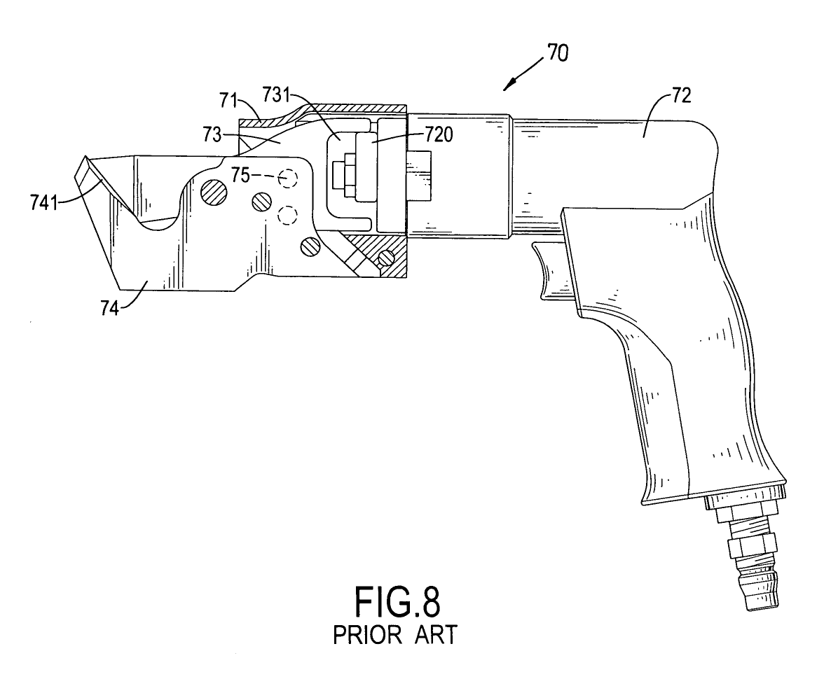

FIG. 9 is a top view in partial section of the conventional electric nibbler in FIG. 8.

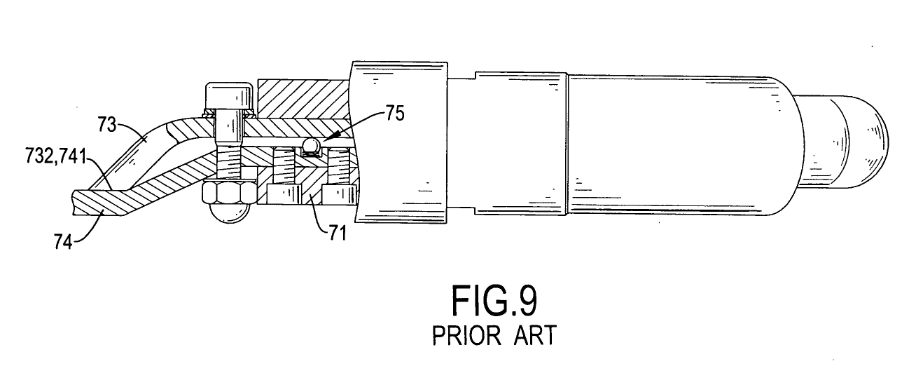

### DETAILED DESCRIPTION OF THE PREFERRED EMBODIMENT

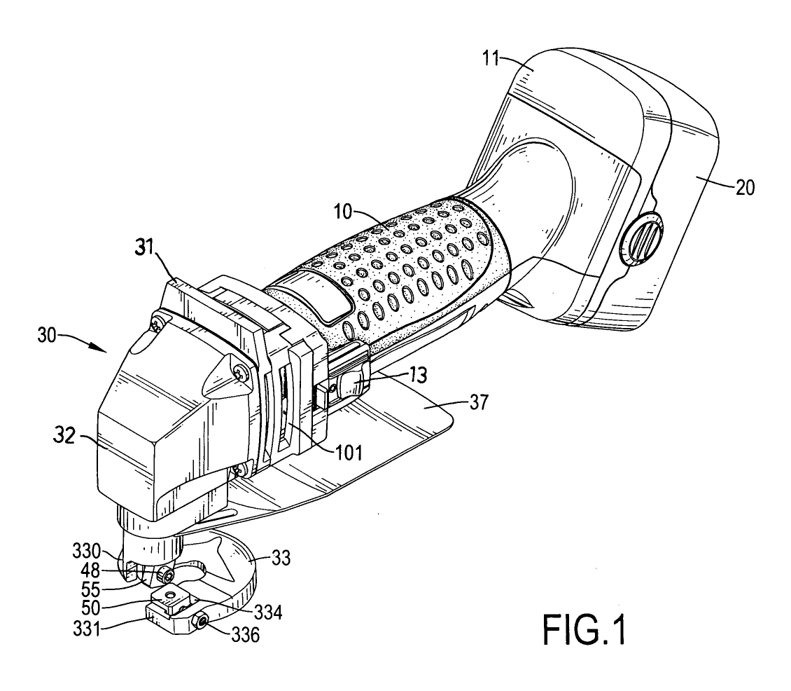

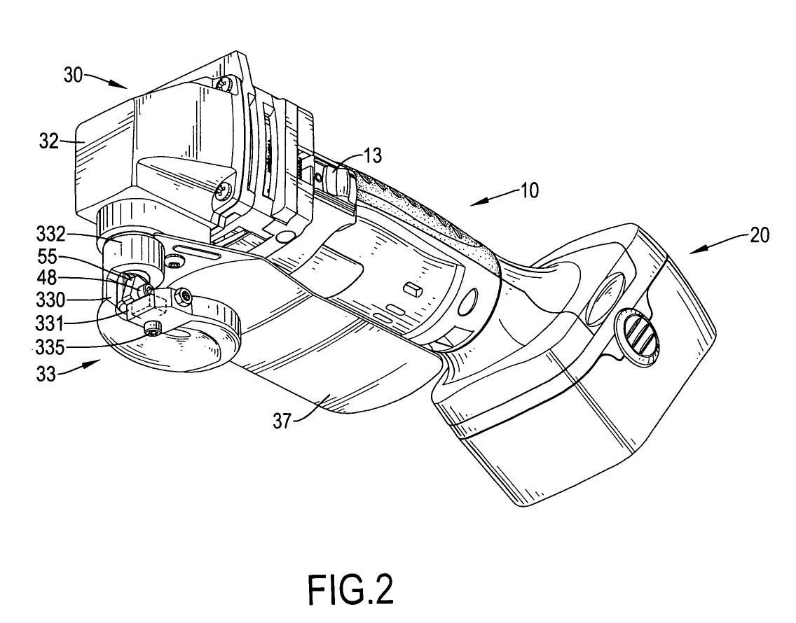

With reference to FIGS. 1 to 3, an electric nibbler in accordance with the present invention comprises a handle (10), a battery package (20), a front cover (30), a base (33), a lower blade (50), an optional safety plate (37), a drive device (15), a transmitting device (40) and an upper blade (55).

The handle (10) is hollow, is implemented with two half-casings and has a front end, a rear end, an interior, an outer surface, a battery seat (11), multiple ventilating holes (101) and a switch (13). The battery seat (11) is formed on the rear end of the handle (10). The ventilating holes (101) are formed through the outer surface of the handle (10) between the front end and the rear end and are communicated with the interior of the handle (10). The switch (13) is mounted on the outer surface of the handle (10) near the front end.

The battery package (20) is detachably attached to the battery seat (11) of the handle (10), is electrically connected to the switch (13) of the handle (10) and has a chamber. The chamber of the battery package (20) is used to hold batteries for supplying electric power to the drive device (15) inside.

The front cover (30) is mounted securely to the handle (10) by multiple bolts extending through the front cover (30) and into handle (10) and has a mounting bracket (31) and a housing (32). The mounting bracket (31) is mounted securely to the front end of the handle (10) and has a through hole (310). The through hole (310) is formed through the mounting bracket (31) and is communicated with the interior of the handle (10). The housing (32) is connected to the mounting bracket (31) by the bolts and has a bottom, an external surface, a mounting recess (320) and a threaded hole. The mounting recess (320) is defined axially on the bottom of the housing (32). The threaded hole is formed radially in the bottom of the housing (32) and is communicated with the mounting recess (320).

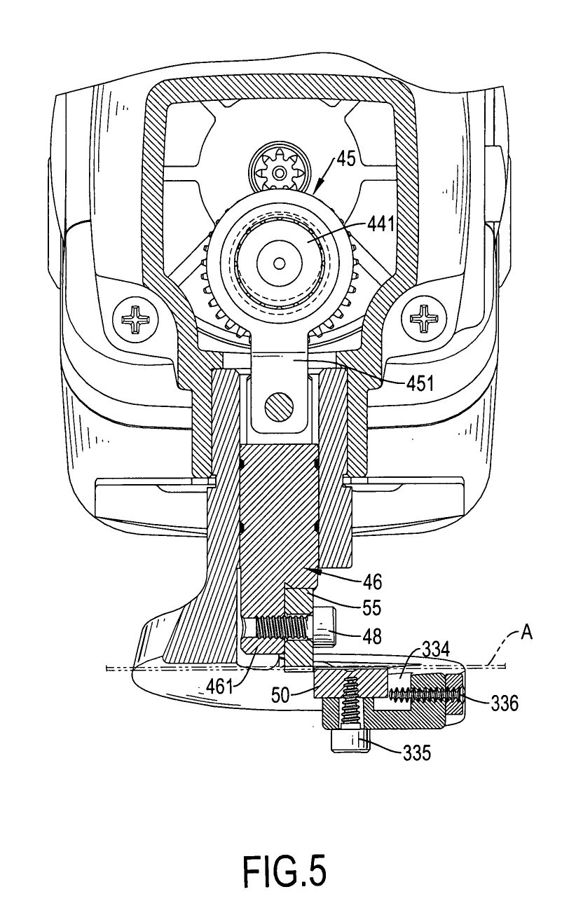

The base (33) is connected securely to the housing (32) of the front cover (30) and has an upper segment (330) and a lower segment (331) to formed a C-shaped configuration. The upper segment (330) is attached securely to the mounting recess (320) of the housing (32) and has an upper end, a mounting pipe (332) and a fastener (34). The fastener (34) is screwed into the threaded hole in the housing (32). The mounting pipe (332) is formed axially on the upper end of the upper segment (330), is attached securely to the mounting recess (320) of the housing (32) and has an outer surface and an indent (333). The indent (333) is formed in the outer surface of the mounting pipe (332) and faces the threaded hole in the housing (32), and the fastener (34) is inserted into the indent (333) in the mounting pipe (332). Thus, the mounting pipe (332) is connected securely to the housing (32) with the fastener (34). With further reference to FIG. 5, the lower segment (331) is formed obliquely with the upper segment (330) and has a lower end, a bottom, an outer side, a blade recess (334), a through hole, a fixing bolt (335) and an orientating bolt (336). The blade recess (334) is defined in the lower end of the lower segment (331). The through hole is formed through the bottom of the lower segment (331) and is communicated with the blade recess (334). The fixing bolt (335) is extended into the blade recess (334) via the through hole. The orientating bolt (336) is screwed with the outer side of the lower segment (331) and is extended into the blade recess (334).

The lower blade (50) may be cubic, is held securely in the blade recess (334) in the lower segment (331) with the fixing bolt (335) being screwed into and the orientating bolt (336) abutting against the lower blade (50).

The safety plate (37) is connected to the external surface of the housing (32) under the handle (10).

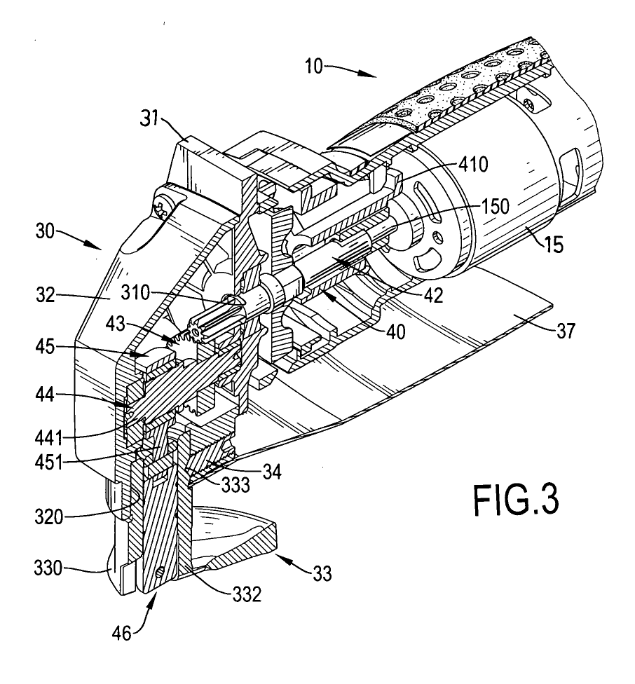

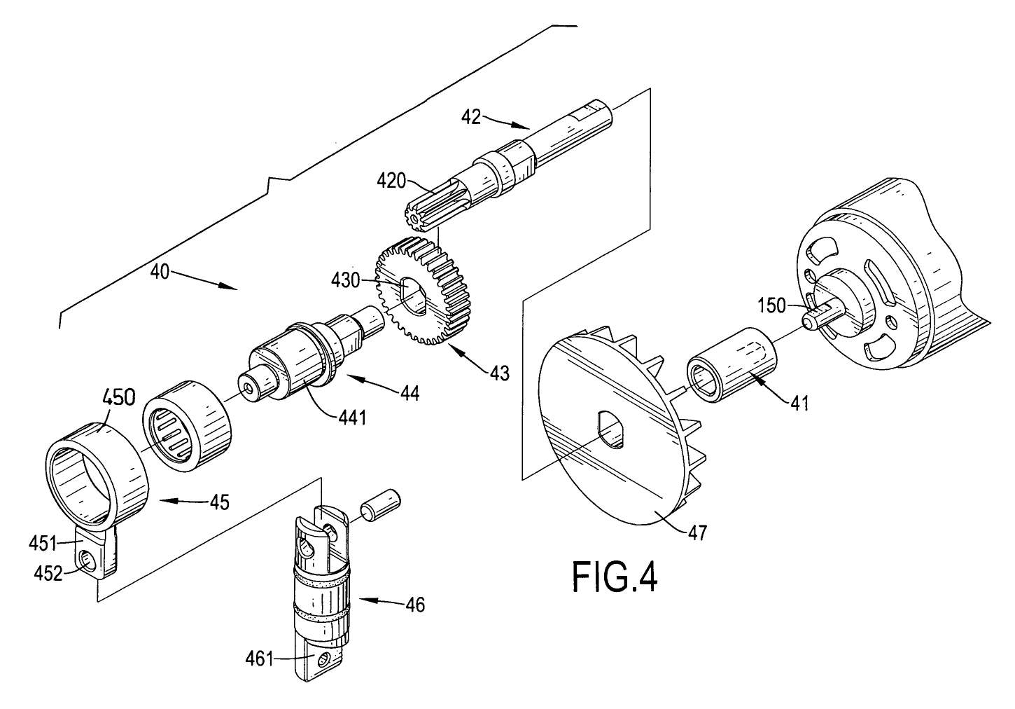

With reference to FIGS. 3 and 4, the drive device (15) may be a motor, is mounted in the handle (10), is electrically connected to battery package (20) and the switch (13) and has a front end and a drive shaft (150). The drive shaft (150) is mounted rotatably on the front end of the drive device (15).

The transmitting device (40) is connected to the drive device (15) and has a connecting tube (41), a transmitting shaft (42), a fan (47), a drive axle (44), a gear wheel (43), a crank (45) and a piston rod (46). The connecting tube (41) is mounted securely around the drive shaft (150) of the drive device (15). The transmitting shaft (42) is mounted securely in the connecting tube (41) and has a proximal end, a distal end and multiple teeth (420). The proximal end of the transmitting shaft (42) is inserted securely into the connecting tube (41). The distal end of the transmitting shaft (42) is extended through the through hole (310) of the mounting bracket (31). The teeth (420) is formed around the distal end of the transmitting shaft (42). The fan (47) is mounted around the transmitting shaft (42) between the connecting tube (41) and the mounting bracket (31) and corresponds to the ventilating holes (101) in the handle (10). The drive axle (44) is connected rotatably to the mounting bracket (31) and the housing (32) below the distal end of the transmitting shaft (42) and has a rear end, a front end and an eccentric post (441). The rear end of the drive axle (44) is connected rotatably to the mounting bracket (31). The eccentric post (441) is formed eccentrically on the front end of the drive axle (44) and has a protrusion connected rotatably to the housing (32) and being coaxial with the rear end of the drive axle (44). The gear wheel (43) is mounted securely around drive axle (44) between the rear end and the eccentric post (441), is engaged with the teeth (420) of the transmitting shaft (42) and has a center and a through hole (430). The through hole (430) is formed through the center of the gear wheel (43) and is mounted around the drive axle (44). The crank (45) is connected to the drive axle (44) and has an annular segment (450) and a connecting segment (451). The annular segment (450) may be circular, is mounted around the eccentric post (441) of the drive axle (44) and has a bearing mounted around the eccentric post (441) and an external surface. The connecting segment (451) is formed on the external surface of the annular segment (450), is extended into the mounting pipe (332) of the base (33) and has a pivot hole (452). The pivot hole (452) is formed through the connecting segment (451). The piston rod (46) is connected to the crank (45), is extended movably in the mounting pipe (332) of the base (33) and has a top end and a bottom end (461). The top end of the piston rod (46) is pivotally connected to the connecting segment (451) of the crank (45) with a pivot extending through the pivot hole of the connecting segment (451). The bottom end of the piston rod (46) is movably extended out the mounting pipe (332) and has a threaded hole and a setscrew (48). The threaded hole is formed through the bottom end (461) of the piston rod (46). The setscrew (48) is screwed into the threaded hole in the bottom end (461). When the switch (13) on the handle (10) is pressed, the connecting tube (41) is rotated by the drive shaft (150) of the drive device (15) and the transmitting shaft (42) is rotated with the connecting tube (41). Then, the drive axle (44) is rotated with the engagement of the teeth (420) on the transmitting shaft (42) and the gear wheel (43). When the drive axle (44) is rotated, the eccentric post (441) will make the crank (45) moving up and down in the housing (32) and the piston rod (46) can be moved up and down along the mounting pipe (332).

The upper blade (55) may be cubic and is connected securely to the bottom end (461) of the piston rod (46) with the setscrew (48) extending through the upper blade (55) and screwed into the threaded hole in the piston rod (46). The upper blade (55) is arranged at an angle relative to the lower blade (50).

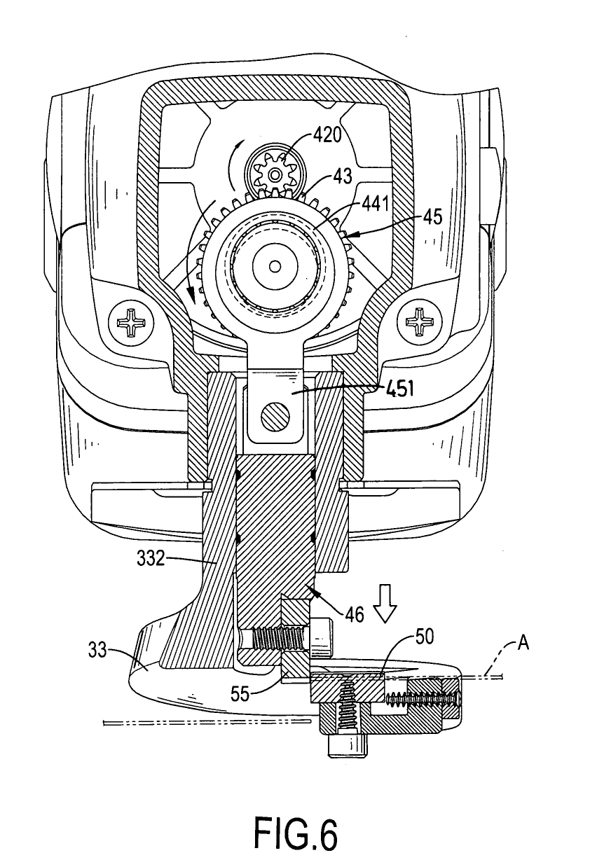

With reference to FIGS. 5 and 6, in use, the sheetmetal (A) is inserted between the blades (50, 55), and the switch (13) is switched on to drive the upper blade (55) to move relative tot he lower blade with the transmission of the drive device (15) and the transmitting device (40). Thus, the sheetmetal (A) can be cut by the blades (50, 55) easily and quickly.

The electric nibbler as described has the following advantages.

1. The sheetmetal (A) is divided by the shearing force provided by the blades (50, 55), so no metal filings will generate. Therefore, the material of the sheetmetal will not be wasted and the working space will not be messed.

2. The safety plate (37) connected to the external surface of the housing (32) under the handle (10) can keep the user from touching the operating blades (50,55), so the user can be prevented from being injured.

3. The sheetmetal (A) can be supported by the base (33) during the cutting process, and this can improve the cutting speed of the electric nibbler.

4. Because the blades (50, 55) are cubic, the blades (50, 55) are only rotated with an angle to move away the worn edge of the blades (50,55). To change new blades (50, 55) when one edge of the blades (50, 55) has been worn down is unnecessary.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An electric nibbler with a latch assembly having
a handle being hollow and having
a front end;
a rear end;
an interior;
a battery seat being formed on the rear end of the handle; and
a switch being mounted on the outer surface of the handle near the front end;
a battery package being detachably attached to the battery seat of the handle and being electrically connected to the switch of the handle;
a front cover being mounted securely to the handle and having
a mounting bracket being mounted securely to the front end of the handle and having a through hole communicated with the interior of the handle; and
a housing being connected to the mounting bracket and having
a bottom;
an external surface;
a mounting recess being formed axially in the bottom of the housing; and
a threaded hole being formed radially in the bottom of the housing and being communicated with the mounting recess;
a base being C-shaped, being connected securely to the housing of the front cover and having
an upper segment being attached securely to the mounting recess of the housing and having
an upper end; and
a mounting pipe being formed axially on the upper end of the upper segment and being attached securely to the mounting recess of the housing; and
a lower segment being formed obliquely with the upper segment;
a lower blade being connected securely on the lower segment;
a drive device being mounted in the handle, electrically connected to battery package and the switch and having
a front end; and
a drive shaft being mounted rotatably on the front end of the drive device;
a transmitting device being connected to the drive device and having
a connecting tube being mounted securely around the drive shaft of the drive device;
a transmitting shaft being mounted securely to the connecting tube and having
a proximal end being inserted securely into the connecting tube;
a distal end being extended through the through hole of the mounting bracket; and
multiple teeth being formed around the distal end of the transmitting shaft;
a drive axle being connected rotatably to the mounting bracket and the housing below the distal end of the transmitting shaft and having
a rear end being connected rotatably to the mounting bracket;
a front end; and
an eccentric post being formed eccentrically on the front end of the drive axle and having a protrusion connected rotatably to the housing and being coaxial with the rear end of the drive axle;
a gear wheel being mounted securely around drive axle between the rear end and the eccentric post, being engaged with the teeth of the transmitting shaft and having
a center; and
a through hole being formed through the center of the gear wheel and being mounted around the drive axle;
a crank being connected to the drive axle and having
an annular segment being mounted around the eccentric post of the drive axle and having an external surface; and
a connecting segment being formed on the external surface of the annular segment, being extended into the mounting pipe of the base and having a pivot hole formed through the connecting segment; and
a piston rod being pivotally connected to the crank with a pivot, being extended movably in the mounting pipe of the base and having
a top end connected pivotally to the connecting segment of the crank with the pivot post; and
a bottom end being movably extended out the mounting pipe; and
an upper blade being connected securely to the bottom end of the piston rod, being arranged at an angle relative to the lower blade.

2. The electric nibbler as claimed in claim 1, wherein
the handle has
an outer surface; and
multiple ventilating holes being formed through the outer surface of the handle and being communicated with the interior of the handle; and
the transmitting device has a fan being mounted around the transmitting shaft between the connecting tube and the mounting bracket and corresponding to the ventilating holes in the handle.

3. The electric nibbler as claimed in claim 1, wherein the electric nibbler has a safety plate connected to the external surface of the housing under the handle.

4. The electric nibbler as claimed in claim 1, wherein
the lower segment of the base has
a lower end;
a bottom;
an outer side;
a blade recess being defined in the lower end of the lower segment;
a through hole being formed in the bottom of the lower segment and being communicated with the blade recess;
a fixing bolt being extended into the blade recess via the through hole and screwed into the lower blade; and
an orientating bolt being screwed into the outer side of the lower segment, being extended into the blade recess and abutting against the lower blade; and
the lower blade being cubic, being held securely in the blade recess in the lower segment with the fixing bolt and the orientating bolt.

5. The electric nibbler as claimed in claim 1, wherein
the bottom end of the piston rod has
a threaded hole being formed through the bottom end of the piston rod; and
a setscrew extending through the upper blade and being screwed into the thread hole of the bottom end; and
the upper blade being cubic, being connected securely to the bottom end of the piston rod with the setscrew.

6. The electric nibbler as claimed in claim 1, wherein
the mounting pipe has
an outer surface; and
an indent being formed in the outer surface of the mounting pipe and facing to the threaded hole of the housing; and
the upper segment of the base has a fastener being screwed into the threaded hole of the housing and inserted into the indent in the mounting pipe.

7. The electric nibbler as claimed in claim 1, wherein the annular segment of the crank has a bearing mounted around the eccentric post of the drive axle.

8. The electric nibbler as claimed in claim 2, wherein the electric nibbler has a safety plate connected to the external surface of the housing under the handle.

9. The electric nibbler as claimed in claim 2, wherein
the lower segment of the base has
a lower end;
a bottom;
an outer side;
a blade recess being defined in the lower end of the lower segment;
a through hole being formed in the bottom of the lower segment;
a fixing bolt being extended into the blade recess via the through hole and screwed into the lower blade; and
an orientating bolt being screwed into the outer side of the lower segment, being extended into the blade recess and abutting against the lower blade; and
the lower blade being cubic, being held securely in the blade recess in the lower segment with the fixing bolt and the orientating bolt.

10. The electric nibbler as claimed in claim 2, wherein
the bottom end of the piston rod has
a threaded hole being formed through the bottom end of the piston rod; and
a setscrew extending through the upper blade and being screwed into the thread hole of the bottom end; and
the upper blade cubic, being connected securely to the bottom end of the piston rod with the setscrew.

11. The electric nibbler as claimed in claim 2, wherein
the mounting pipe has
an outer surface; and
an indent being formed in the outer surface of the mounting pipe and facing to the threaded hole of the housing; and
the upper segment of the base has a fastener being screwed into the threaded hole of the housing and inserted into the indent in the mounting pipe.

12. The electric nibbler as claimed in claim 2, wherein the annular segment has a bearing mounted around the eccentric post of the drive axle.
